(19) United States
(12) Patent Application Publication
(10) Pub. No.: US 2026/0129373 A1
(43) Pub. Date: May 7, 2026

(54) ELECTROSTATIC SPEAKER SYSTEM FOR A VEHICLE

(71) Applicant: Jaguar Land Rover Limited, Coventry (GB)

(72) Inventor: Paul Wiles, Coventry (GB)

(21) Appl. No.: 19/376,232

(22) Filed: Oct. 31, 2025

(30) Foreign Application Priority Data
Nov. 1, 2024 (GB) 2416142.4

(51) Int. Cl. H04R 19/02; H04R 1/02

(52) U.S. Cl. CPC H04R 19/02; H04R 1/025; H04R 2499/13

(57) ABSTRACT

Aspects of the present invention relate to an electrostatic speaker system, a vehicle audio system comprising the electrostatic speaker system, and a vehicle comprising the vehicle audio system. The electrostatic speaker system comprises a voltage conversion module and an electrostatic transducer. The voltage conversion module is configured to receive a low-voltage ‘speaker-level’ signal from a vehicle audio source; and to convert the received low-voltage speaker-level signal to a high-voltage audio signal. The electrostatic transducer is configured to receive the high-voltage audio signal (from the voltage conversion module) and to convert this high-voltage audio signal into sound waves for output by the electrostatic speaker system. The voltage conversion module comprises at least one audio transformer configured to step-up the voltage of the low-voltage speaker-level signal to a predefined voltage level for the high-voltage audio signal.

### CROSS-REFERENCE TO RELATED APPLICATIONS

This application claims priority to Great Britain Patent Application No. GB2416142.4, filed 1 November 2024, the entire contents of which are incorporated herein by reference as if fully set forth below.

### TECHNICAL FIELD

The present disclosure relates to a speaker system, particularly in relation to the use of an electrostatic speaker system in an audio system for a vehicle. Aspects of the invention relate to an electrostatic speaker system, to a vehicle audio system, and to a vehicle.

### BACKGROUND

Audio systems in vehicles undergo periodic upgrades and improvement, particularly at the present time where there is a need to evolve and adapt vehicle audio system designs based on the ever-changing requirements of consumers as well as the vehicle industry as a whole.

For example, consumers desire improvements to be made in the sound quality of their vehicle audio systems. The demand for increasingly immersive and/or interactive experiences when listening to audio in their vehicles is also growing. Additionally, in recent years, there has been a drive to adopt an increasingly sustainable and eco-friendly approach to vehicle design, for example as can be seen from the rise in use of clean technologies, and the increased adoption of electric (or hybrid) vehicles.

It is desirable to be able to retrofit the most up-to-date and modern vehicle audio systems into existing designs of vehicle sound and power systems, so as to avoid the costs associated with large-scale alterations of underlying vehicle design.

It is an aim of the present invention to address one or more of the disadvantages associated with the prior art.

### SUMMARY OF THE INVENTION

Aspects and embodiments of the invention provide an electrostatic speaker system, a vehicle audio system comprising the electrostatic speaker system, and a vehicle comprising the vehicle audio system as claimed in the appended claims.

According to an aspect of the present invention, there is provided an electrostatic speaker system for a vehicle. This speaker system comprises a voltage conversion module and an electrostatic transducer. The voltage conversion module is configured to receive a low-voltage ‘speaker-level’ signal from a vehicle audio source; and to convert the received low-voltage speaker-level signal to a high-voltage audio signal. The electrostatic transducer is configured to receive the high-voltage audio signal (from the voltage conversion module) and to convert this high-voltage audio signal into sound waves for output by the electrostatic speaker system. The voltage conversion module comprises at least one audio transformer configured to step-up the voltage of the low-voltage speaker-level signal to a predefined voltage level for the high-voltage audio signal.

As used hereinabove, the terms ‘low-voltage’ and ‘high-voltage’ are primarily intended to enable a distinction to be made between the relative voltages of the input and output signals of the voltage conversion module – namely, that the voltage of the signal output is significantly higher than the voltage of the input signal. Additionally, the term ‘speaker-level’ signal is a commonly used technical term that would be understood by a skilled person in the relevant technical field to indicate an audio signal that has already undergone amplification. For example, in the above case, the speaker-level signal corresponds to an audio signal output from the vehicle’s audio system which includes an audio amplifier. This term is used here in contrast to a ‘line-level’ signal which is also a commonly used technical term that would be understood by a skilled person in the relevant technical field to refer to a different type of signal, and more particularly to indicate an audio signal pre-amplification.

The term ‘audio transformer’ as used herein is also a commonly used technical term that would be understood by a skilled person in the relevant technical field to indicate that the transformer in question corresponds to one that is particularly suitable for processing audio signals as it creates low / minimal amounts of distortion in the typical audio frequency range.

The above-described electrostatic speaker system is able to convert incoming audio signals to a predefined output voltage level that is needed to operate the electrostatic transducer, since the operational voltages of electrostatic transducers are typically much higher than the voltages that are used for audio signals in a standard vehicle audio system. As a result of implementing the above-described system, the vehicle audio source that is used to provide the input signal can correspond to the standard audio source that is currently installed in vehicle audio speaker systems – i.e., a normal audio system-and-amplifier combination implemented in existing vehicles. As such, the above-described electrostatic speaker system allows for retrofitting of the electrostatic transducer into existing vehicle systems to provide an improved audio quality and efficiency over existing audio speakers, whilst nevertheless maintaining as many of the original vehicle audio system components as possible.

Optionally, the transformer is a toroidal transformer.

In some instances, the speaker-level signal has a voltage in the range between 5 and 50 V, for example, between 5 and 45 V, and more particularly between 8 and 42 V. In some scenarios, the predefined voltage level is between 550 and 650 V, and more particularly is around 600V.

In some instances, the above-described electrostatic speaker system is disposed in any one of the following vehicle components: (a) a head restraint of a vehicle seat (sometimes colloquially referred to as a ‘head rest’); (b) an interior trim component of the vehicle (for example, a panel of the vehicle interior, such as a vehicle door panel or a front / dashboard panel); and (c) a seat of the vehicle, for example in the upright supporting portion of a (front) seat of the vehicle.

It will therefore be appreciated that, due to the co-location of the voltage converter module in the vehicle component along with the electrostatic transducer to provide the necessary voltage step-up functionality in situ, the vehicle audio signal may still be used as an input to the electrostatic speaker system, even though the vehicle audio source itself is not installed close to the location of the speaker.

Optionally, the audio signal lies in a frequency range between 125 Hz to 50 kHz. The electrostatic speaker system is found to be particularly suitable for replacing existing vehicle audio speakers in that range of frequencies. However, the audio signal may also lie in the frequency range of 20 Hz to 20 kHz.

In some instances, the electrostatic speaker system further comprises a high voltage module configured to output high voltage power to control the electrostatic transducer.

Optionally, the electrostatic speaker system may be configured to be powered by the battery of the vehicle. In some instances, this battery power is provided to or via the high voltage module.

The electrostatic speaker system described above may be configured and/or designed to be retrofittable into an existing vehicle audio system. This means that the electrostatic speaker system would be compatible with existing vehicle audio systems and can be inserted to replace certain components of existing vehicle audio systems in a straightforward and simple manner, despite the differences in voltage requirements. As far as possible, many of the components of the existing audio systems can be retained by using the above-described electrostatic speaker system, thereby minimising the disruption associated with the retrofitting process.

According to another aspect of the present invention, there is provided a vehicle audio system comprising a plurality of any one of the above-described electrostatic speaker systems. In some instances, the plurality of electrostatic speaker systems may be of different sizes and/or may be disposed in a variety of different locations within the vehicle. The electrostatic speaker systems described above are compact and simple to implement and install, thereby making them a good choice to replace various components in existing audio systems throughout the vehicle.

According to another aspect of the present invention, there is provided a vehicle comprising any of the electrostatic speaker systems as described above, or the vehicle audio system as described above.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic illustration of an existing vehicle audio system comprising a typical audio speaker;

FIG. 2 shows a schematic illustration of a vehicle audio system comprising an electrostatic speaker system in accordance with an embodiment of the present invention;

FIG. 3 shows a schematic illustration of a vehicle implementing the vehicle audio system of FIG. 2 in accordance with an embodiment of the present invention; and

FIG. 4 shows top plan views illustrating a side-by-side comparison of an existing vehicle audio system implemented in a vehicle, and an example implementation of a vehicle audio system comprising a plurality of electrostatic speaker systems implemented in the same vehicle in accordance with an embodiment of the present invention.

### DETAILED DESCRIPTION

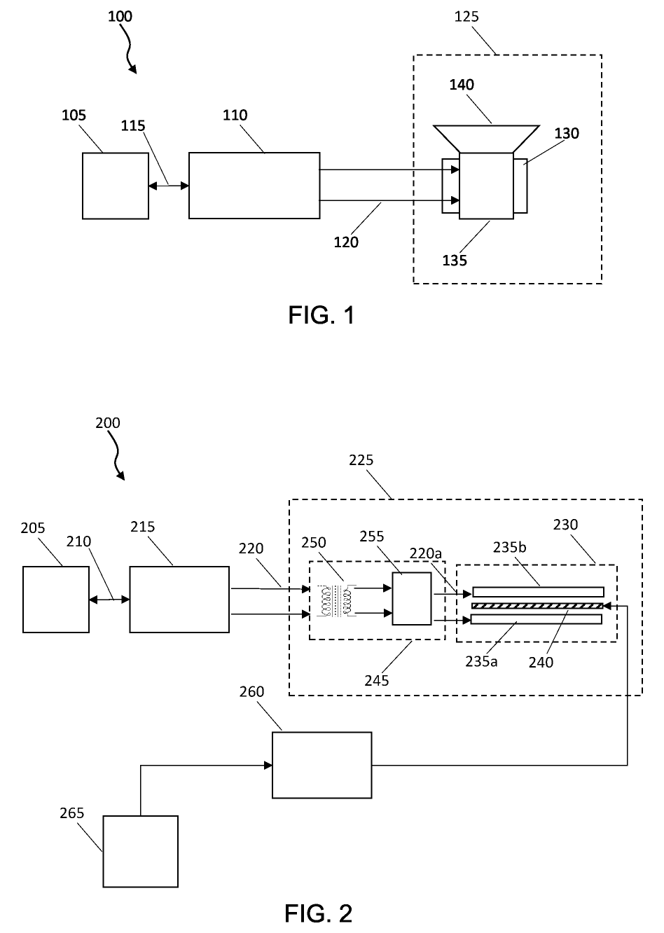

In order to better understand the implementation context and advantages of the electrostatic speaker system of the present invention, a description of an existing vehicle audio system (comprising a typical audio speaker which the electrostatic speaker system is intended to replace) will now be provided with reference to FIG. 1.

As shown in that figure, the existing vehicle audio system 100 comprises a vehicle audio source 105 connected to an audio amplifier 110 via a digital bus 115. The audio amplifier 110 amplifies the incoming signal from the audio source 105 and is configured to output a relatively low-voltage ‘speaker-level’ audio signal 120. This audio signal 120 has an associated voltage of the order of a few tens of volts: for example, in the range of 2 to 50 V, particularly between 5 and 45 V, and more particularly between 8 and 42 V. The term ‘speaker-level’ signal is a commonly used technical term that would be understood by a skilled person in the relevant technical field to indicate an audio signal that has already undergone amplification. This term is used here to highlight the contrast between the above-described signal and a ‘line-level’ signal, which is also a commonly used technical term that would be understood by a skilled person in the relevant technical field to refer to a different type of signal, and more particularly to indicate an audio signal pre-amplification. The audio signal lies in a frequency range that is between around 100 Hz and 60 kHz, and more specifically may be between around 125 Hz to 50 kHz; and/or anywhere between around 20 Hz and 20 kHz.

The vehicle audio system 100 further comprises an audio speaker system 125 which provides audio transducer functionality: the audio signal 120 that is output by the audio amplifier 110 is transmitted to the audio speaker system 125, which is configured to convert the incoming audio signal 120 into sound waves. More specifically, the audio speaker system 125 comprises a magnet 130 and a cylindrical coil 135 of wire located between the poles of the magnet 130. The incoming audio signal 120 is transmitted through the coil 135 in alternating directions, causing the coil to move reciprocally (back and forth) between the poles of the magnet 130, based on Faraday’s law. The audio speaker system 125 further comprises a speaker cone 140 that is attached to one end of the coil 135 and is therefore also driven reciprocally in time with the movements of the coil 135. As the speaker cone 140 moves, it generates pressure waves in the surrounding air which propagate and are detected by a listener as sound waves.

The present Applicant has appreciated that other types of transducers exist which can generate sound waves and hence function as speakers. For example, electrostatic transducers could be used in a speaker system to generate audio waves instead of the existing audio speaker system 125 described above. As the technically skilled person would be aware, electrostatic transducers in their most general sense are designed to generate sound via a force exerted on a membrane (or diaphragm) that is suspended in an electrostatic field. In more detail, electrostatic transducers typically comprise a membrane (e.g., a flexible sheet coated in an electrically conductive material) that is sandwiched between two electrically conductive stators (or grids), leaving a small air gap on either side of the membrane. The incoming audio signal is used to drive the stators, resulting in the generation of an electrostatic field proportional to the audio signal between the stators. The membrane is charged and held at a high voltage relative to the stators. A force is thus exerted upon the membrane causing it to move, driving the air on either side of the membrane to generate pressure waves (sound waves).

The present Applicant has appreciated that there are multiple benefits associated with the use of electrostatic transducers (e.g., improved audio response and sound quality obtained, improved versatility of implementation), and that it would be useful to replace the existing vehicle audio speaker system 125 with an electrostatic speaker system in certain scenarios.

The present Applicant has nevertheless also appreciated that in performing this replacement and particularly when retrofitting electrostatic speaker systems into existing vehicle audio systems, various challenges need to be overcome. At least some of these challenges stem from the need to provide the appropriate strength of audio signal to the electrostatic speaker systems, since to generate a sufficient field strength to cause the appropriate movement of the membrane, the audio signal sent to the stators must be of a high voltage (e.g. on the order of several hundreds or thousands of volts). However, as mentioned earlier, the audio signal 120 that is output by the amplifier in existing vehicle audio systems is a ‘speaker-level’ signal which has a relatively low voltage of only a few tens of volts (at the most).

An implementation of a vehicle audio system 200 whereby an electrostatic speaker system has been integrated into (retrofitted into) an existing vehicle audio system, in accordance with aspects of the present invention, will now be described with reference to FIG. 2.

The retrofitted vehicle audio system 200 comprises a vehicle audio source 205 connected to an audio amplifier 210 via a digital bus 215. The audio amplifier 210 amplifies the incoming signal from the audio source 205 and is configured to output a relatively low-voltage ‘speaker-level’ audio signal 220. These components are the same as the audio source 105, audio amplifier 110 and digital bus 115 described previously with reference to FIG. 1; the output speaker-level audio signal 220 therefore corresponds to the audio signal 120 output in FIG. 1. In other words, this portion of the vehicle audio system remains substantially unchanged following the retrofitting process.

The vehicle audio system 200 further comprises an electrostatic speaker system 225 which provides transducer functionality. Specifically, the electrostatic speaker system 225 comprises an electrostatic transducer 230 that is configured to convert the audio signal 220 that is output by the audio amplifier 210 into sound waves. In more detail, the electrostatic transducer 230 comprises a pair of stators 235a, 235b and a membrane 240 that is located between the pair of stators 235a, 235b. These components are configured to operate in substantially the manner described above with regard to the general electrostatic transducer – namely, the stators 235a, 235b are configured to receive an incoming audio signal and generate an electrostatic field; and the membrane 240 is configured to move within the electrostatic field and create sound waves.

Additionally, the electrostatic speaker system 225 further comprises a voltage conversion module 245 that is configured to receive the audio signal 220 output by the audio amplifier 215, and to convert this input signal (which as previously mentioned corresponds to a relatively low-voltage speaker level signal) into a relatively high-voltage audio signal 220a that can be used by the stators 235a, 235b to generate an electrostatic field of sufficient strength to move the membrane 240.

In order to perform its functionality, the voltage conversion module 245 comprises at least one audio transformer 250 (i.e., a transformer that is of audio quality) that is configured to ‘step-up’ the voltage of the incoming audio signal 220 to a predefined voltage level that is suitable for operating the electrostatic transducer 230 (and specifically the stators 235a, 235b) in the desired manner. This predefined voltage value is typically of the order of several hundred V (for example, between around 500 V to 700 V etc.); in particular instances it is between around 550 and 650 V, and more particularly is around 600 V. The transformer 250 that is used in the voltage conversion module 245 may correspond to any suitable transformer that is of audio-quality and capable of providing the necessary step-up functionality for the audio signals. In one specific example, the transformer 250 may be implemented as a toroidal transformer.

Advantageously, the use of an audio transformer in the voltage conversion module 245 to provide the desired step-up of voltage for the signal utilises a simple and straightforward solution that optimises the desired outcome, whilst minimising the additional number of electronics components that are required to be installed. As such, the physical size of the voltage conversion module 245 is minimised overall, which is useful as this module needs to be installed in close physical proximity to the electrostatic transducer 230 in order to provide the necessary functionality. As a result, the voltage conversion module 245 can be combined with the electrostatic transducer 230 without unduly increasing the size of the electrostatic speaker system 225 as a whole. This is particularly advantageous when replacing speaker systems installed in locations within vehicles where space may be limited.

Additional electronic (processing) components may also be provided as part of the electrostatic speaker system 225, such as smoothing components 255 that are configured to perform signal smoothing on the stepped-up signal prior to its input to the electrostatic transducer 230. Although these smoothing components are shown in FIG. 2 as forming part of the voltage conversion module 245, they may instead be provided as a separate module entirely.

As noted previously, for an electrostatic transducer to be operated correctly, the membrane that is located between the stators needs to be charged to a high potential (voltage). As such, the vehicle audio system 200 further comprises a high voltage module 260 that is configured to provide the necessary high voltage power to charge the membrane 240 in the electrostatic transducer 230. The high voltage module 260 is, in essence, a small voltage conversion module (box) that can convert an input low voltage (12V) to a significantly higher output voltage. The high voltage module 260 can be installed in a variety of different locations within the vehicle having an appropriately sized space, for example in the loadspace area. The appropriate level of power that this high voltage module 260 provides is typically in the order of several thousand Volts (for example, between around 2 kV and 5 kV etc.); in particular instances it is between 2.5 kV and 4kV, more particularly between 2kV and 3kV, and still more particularly is around 3 kV. Other voltages may be more suitable in other implementations.

A power source 265, for providing the appropriate power to the high voltage module 260, also forms part of the vehicle audio system 200. This power source 265 may correspond to the standard (vehicle) battery that is used to power other components of the vehicle in which the audio system 200 is to be installed. As a result, the vehicle audio system 200 can seamlessly integrate (and be retrofit) into the existing vehicle systems despite the differing requirements in power and signal strength of the electrostatic speaker system 225 relative to the standard audio system 125.

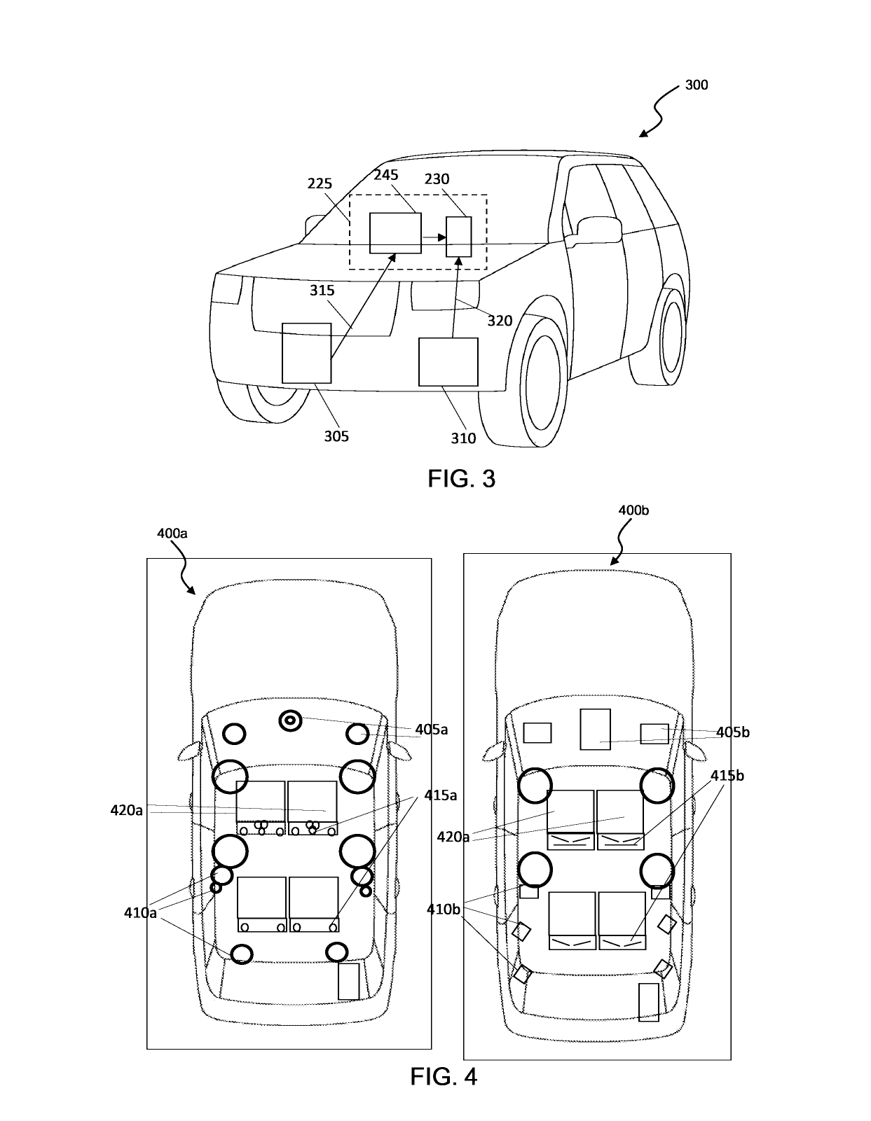

Examples of how of the improved vehicle audio system 200 may be implemented into a vehicle and seamlessly integrated with existing vehicle and audio system components will now be described with reference to FIGS. 3 and 4.

FIG. 3 shows a schematic illustration of a vehicle 300 in which the vehicle audio system 200 described above may be retrofit to replace the existing vehicle audio system 100, according to an aspect of the invention.

The vehicle 300 comprises a vehicle audio source 305 and a vehicle battery 310. The vehicle audio source 305 corresponds to the combined audio source 105, 205 audio amplifier 110, 210 and digital bus 115, 225 components that were described previously with reference to FIGS. 1 and 2, and which form part of the existing vehicle audio system 100. The vehicle audio source 305 is configured to output a relatively low-voltage speaker-level audio signal 315, which corresponds to the audio signal 120, 220 described previously.

As shown in the figure, the electrostatic speaker system 225, and specifically the electrostatic transducer 230 and the voltage conversion module 245, may be installed within the vehicle interior. This is shown in general in FIG. 3, but as will be appreciated subsequently when considering FIG. 4, a plurality of electrostatic speaker systems 225 may be installed in the vehicle 300, for example, in specific components of the vehicle where audio speakers 125 are currently installed.

The vehicle audio source 305 is operatively connected to the electrostatic speaker system 225, and more specifically to the voltage conversion module 245, such that the speaker-level audio signal 315 is provided as an input to the voltage conversion module 245 for step-up voltage conversion (in the manner described with reference to FIG. 2). The vehicle battery 310 is operatively connected to the electrostatic speaker system 225, and more specifically to the electrostatic transducer 230 (e.g., to the membrane 240) such that power 320 output by the vehicle battery 310 can be used to charge the membrane 240 to an appropriate level for operation of the electrostatic transducer and consequential output of sound waves.

FIG. 4 shows a schematic illustration of first and second vehicle implementations 400a, 400b in plan view: the two vehicle implementations correspond to the same overall vehicle type and design, with a primary exception being that in the first vehicle implementation 400a the existing vehicle audio system 100 is installed, whereas in the second vehicle implementation 400b the improved vehicle audio system 200 is installed.

In the first vehicle implementation 400a, the vehicle audio system 100 comprises one or more pluralities of audio speaker systems 405a, 410a, 415a, each corresponding to one of the audio speaker systems 125 described previously and being located in one of a variety of vehicle interior components. For example, a first plurality of audio speaker systems 405a is installed within one or more vehicle front panel components (e.g., in a dashboard or dashboard-equivalent component) of the first vehicle implementation 400a. A second plurality of audio speaker systems 410a is installed within one or more vehicle side panel and/or door components (e.g., in / near the footwell, in the door panel) of the first vehicle implementation 400a. A third plurality of audio speaker systems 415a is installed within one or more portions of a vehicle seating arrangement of the first vehicle implementation 400a. For example, one or more of the audio speaker systems 415a is installed in a head restraint (also referred to colloquially as a ‘headrest’) of each of a plurality of seats 420a in the vehicle seating arrangement.

In the second (improved) vehicle implementation 400b, the vehicle audio system 200 comprises one or more pluralities of electrostatic speaker systems 405b, 410b, 415b (each corresponding to one of the electrostatic speaker systems 225 described previously) that are also located in a variety of vehicle interior components. As can be seen in the side-by-side comparison, the first plurality of audio speaker systems 405a – those that are located in the vehicle front panel component – have been replaced by a first plurality of electrostatic speaker systems 405b. Similarly, the second plurality of audio speaker systems 410a – those that are located in the vehicle side panel and/or door components – have been replaced by a second plurality of electrostatic speaker systems 410b. Finally, the third plurality of audio speaker systems 415a – those that are located within portions of the vehicle seating arrangement – have been replaced by a third plurality of electrostatic speaker systems 415b.

As can be seen from FIG. 4, the proposed improved vehicle audio system 200 design in the second vehicle implementation has a reduced number of electrostatic speaker systems 225 in total when compared to the number of audio speakers 125 that are present in the existing vehicle audio system 100. In more detail, it will be appreciated that the replacement of existing speaker systems with the improved speaker systems is not necessarily on a one-for-one basis: some of the audio speaker systems 125 (for example, those in the vehicle seating arrangement) can be replaced with fewer electrostatic speaker systems 225. This reduces the cost of components, and improves the ease with which retrofitting can be performed.

The proposed vehicle audio system 200 therefore provides for an improved ease of installation of the new speaker systems, as well as an improved ease of operation of the newly installed speaker systems, since there are fewer of them. Nevertheless, the quality of the audio output by the vehicle speaker system 200 is maintained (or even improved) due to the inherent improved quality and efficiency of the electrostatic speaker systems themselves. Moreover, the electrostatic speaker systems 225 are able to operate over a relatively wide frequency range (as noted above), and therefore are able to replace a variety of speaker types present in the existing audio systems (including mid-frequency speakers, and high-frequency ‘tweeter’ speakers).

As briefly mentioned above, one reason for being able to maintain a small size of the electrostatic speaker systems 225 is that the voltage conversion module 245 has an appropriate number of components to perform its functionality whilst nevertheless minimising the overall size of that module. As the voltage conversion module 245 needs to be implemented in close physical proximity to the electrostatic transducer 230 to perform its function effectively, the fact that the voltage conversion module 245 is of a beneficially small size means that the overall speaker system is also sized beneficially.

The configuration of the electrostatic speaker system 225 according to aspects of the invention is such that each speaker system is sufficiently small, and yet produces sound of sufficient quality, to enable easy and versatile implementation within the vehicle system. This is particularly advantageous when, as shown in FIG. 4, a plurality of such speaker systems needs to be retrofitted into the vehicle. Moreover, as a result of the design of the electrostatic speaker system 225, the retrofitting process nevertheless allows a significant proportion of the existing vehicle audio system 100 components to be maintained within the vehicle and reused for the new vehicle audio system 200.

Overall, the retrofitting process for the new and improved vehicle audio system 200 is optimised; it can therefore be easily and efficiently replicated in multiple vehicles.

It will be appreciated that various changes and modifications can be made to the present invention without departing from the scope of the present application. For example, it should be appreciated that different vehicles will have different existing vehicle audio system 100 arrangements; and therefore, the exact number of electrostatic speaker systems 225 that are retrofit (as well as their locations) are likely to differ from the illustrative example shown in FIG. 4.

What is claimed is:

1. An electrostatic speaker system for a vehicle comprising:
a voltage conversion module configured to:
receive a low-voltage speaker-level signal from a vehicle audio source; and
convert the low-voltage speaker-level signal to a high-voltage audio signal, wherein the voltage conversion module comprises at least one audio transformer configured to step-up the voltage of the low-voltage speaker-level signal to a predefined voltage level for the high-voltage audio signal; and
an electrostatic transducer configured to receive the high-voltage audio signal and to convert the high-voltage audio signal into sound waves for output by the electrostatic speaker system.

2. The electrostatic speaker system of claim 1, wherein the transformer is a toroidal transformer.

3. The electrostatic speaker system of claim 1, wherein the speaker-level signal has a voltage in the range between 8 and 42V, and the predefined voltage level is around 600V.

4. The electrostatic speaker system of claim 1, and disposed in any one of the following vehicle components: a head restraint of a vehicle seat; an interior trim component of the vehicle; and a front seat of the vehicle.

5. The electrostatic speaker system of claim 1, wherein the audio signal lies in a frequency range between 125 Hz to 50 kHz.

6. The electrostatic speaker system of claim 1, further comprising a high voltage module configured to output high voltage power to control the electrostatic transducer.

7. The electrostatic speaker system of claim 1, configured to be retrofittable into an existing vehicle audio system.

8. The electrostatic speaker system of claim 1, configured to be powered by a battery of the vehicle.

9. A vehicle audio system comprising a plurality of electrostatic speaker systems according to claim 1.

10. The vehicle audio system of claim 9, wherein the plurality of electrostatic speaker systems are of different sizes and/or are disposed in different locations within the vehicle.

11. A vehicle comprising the electrostatic speaker system of claim 1.
